(19) United States
(12) Patent Application Publication
(10) Pub. No.: US 2014/0184108 A1
(43) Pub. Date: Jul. 3, 2014

(54) MOTOR DRIVING SYSTEM

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: JIAN ZHAO, Wuhan (CN); CHONG HE, Wuhan (CN); XIAO-HUI WANG, Wuhan (CN); WEN-JUN HU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/973,687

(22) Filed: Aug. 22, 2013

(30) Foreign Application Priority Data
Dec. 28, 2012 (CN) 2012105821710

(51) Int. Cl. H02P 1/54

(52) U.S. Cl. CPC H02P 1/54
USPC 318/103

(57) ABSTRACT

A motor driving system includes a first switch, a second switch, a third switch, a fourth switch, a first motor, a second motor, a third motor, and a fourth motor. The interconnections between all the switches allows the detection of any one of a number of motors as being unconnected, and allows control of all the motors individually, to avoid a dedicated switching system being necessary for each motor.

### BACKGROUND

1. Technical Field

The present disclosure relates to a motor driving system having a detecting circuit.

2. Description of Related Art

Motors are used in vending machines to push items for sale to an output tray, and customers can reach the items from the output tray. Each motor is driven by a separate MOSFET for rotating. When a number of the motors increases, a great number of MOSFETs are needed to drive the motors, which may increase the costs.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a motor driving system.

FIG. 2 is a circuit diagram of the motor driving system of FIG. 1.

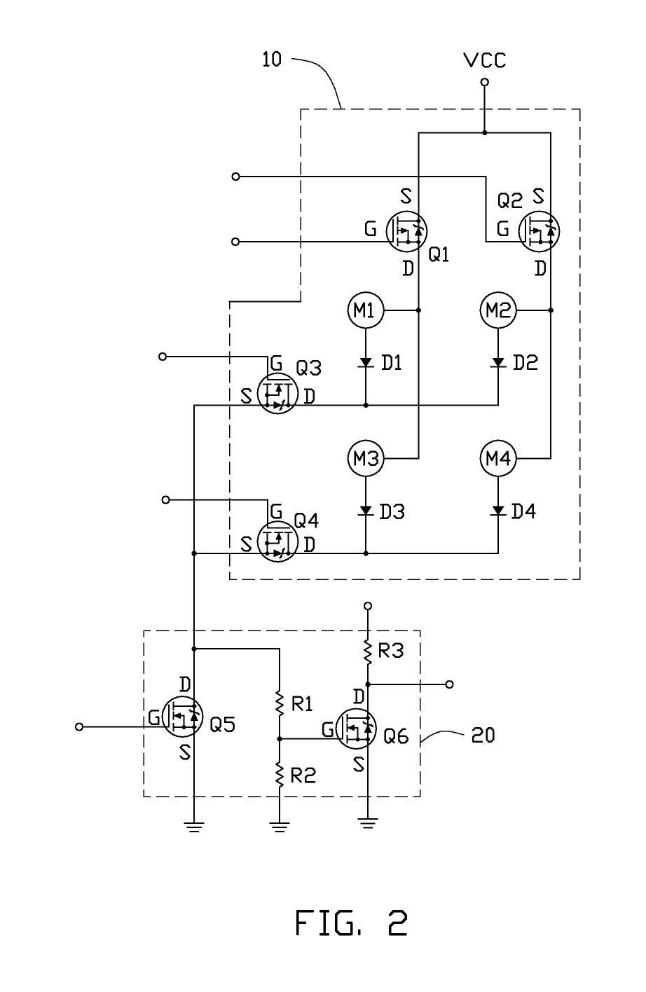

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

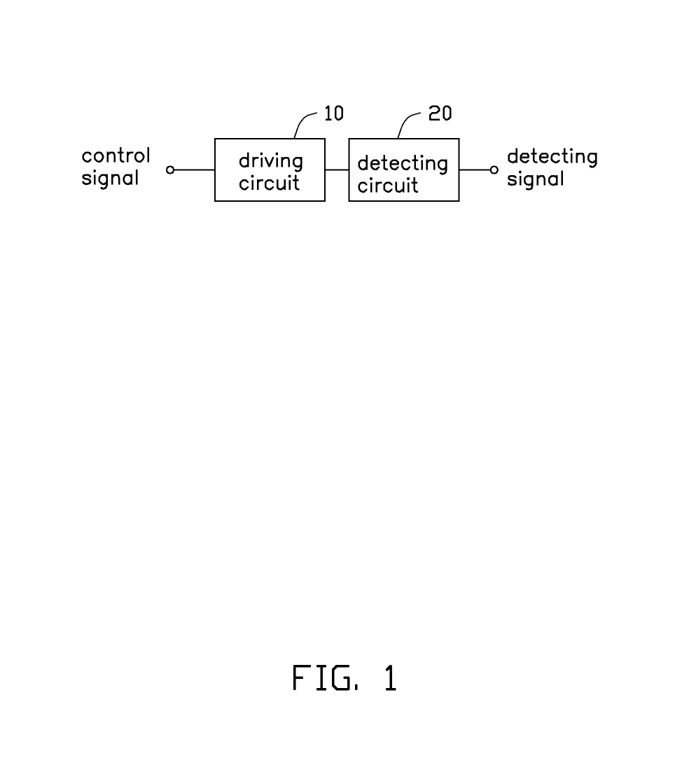

FIG. 1 shows a motor driving system which includes a driving circuit 10 and a detecting circuit 20. The driving circuit 10 receives control signals, and drives motors to rotate according to the control signals. The detecting circuit 20 detects the respective status of each motor, and outputs signals to indicate whether the motors are connected to the system.

The driving circuit 10 includes a first switch Q1, a second switch Q2, a third switch Q3, a fourth switch Q4, a first motor M1, a second motor M2, a third motor M3, a fourth motor M4, a first diode D1, a second diode D2, a third diode D3, and a fourth diode D4. Each of the first switch Q1, the second switch Q2, the third switch Q3, and the fourth switch Q4 includes a first terminal, a second terminal, and a third terminal. Each of the first motor M1, the second motor M2, the third motor M3, and the fourth motor M4 includes an anode and a cathode. Each of the first diode D1, the second diode D2, the third diode D3, and the fourth diode D4 includes an anode and a cathode.

In one embodiment, the first switch Q1, the second switch Q2, the third switch Q3, and the fourth switch Q4 are MOSFETs. The first terminal, the second terminal, and the third terminal always the gate, source, and drain respectively.

The anode of the first motor M1 is electrically connected to the drain of the first switch Q1. The cathode of the first motor M1 is electrically connected to the anode of the first diode D1. The cathode of the first diode D1 is electrically connected to the drain of the third switch Q3. The anode of the second motor M2 is electrically connected to the drain of the second switch Q2. The cathode of the second motor M2 is electrically connected to the anode of the second diode D2. The cathode of the second diode D2 is electrically connected to the drain of the third switch Q3.

The anode of the third motor M3 is electrically connected to the drain of the first switch Q1. The cathode of the third motor M3 is electrically connected to the anode of the third diode D3. The cathode of the third diode D3 is electrically connected to the drain of the fourth switch Q4. The anode of the fourth motor M4 is electrically connected to the drain of the second switch Q2. The cathode of the fourth motor M4 is electrically connected to the anode of the fourth diode D4. The cathode of the fourth diode D4 is electrically connected to the drain of the fourth switch Q4.

Each gate of the first switch Q1, the second switch Q2, the third switch Q3, and the fourth switch Q4 receives a first control signal. The sources of the first switch Q1 and of the second switch Q2 receive a first DC voltage. In one embodiment, the first switch Q1 and the second switch Q2 are P channel MOSFETs. The first diode D1, the second diode D2, the third diode D3, and the fourth diode D4 are Zener diodes. The first DC voltage is +12V.

The detecting circuit 20 includes a fifth switch Q5, a sixth switch Q6, a first resistor R1, a second resistor R2, and a third resistor R3. Each of the fifth switch Q5 and the sixth switch Q6 includes a first terminal, a second terminal, and a third terminal. In one embodiment, the fifth switch Q5 and the sixth switch Q6 are MOSFETs. The first terminal of the fifth switch Q5 receives a second control signal. The second terminal of the fifth switch Q5 is grounded. The third terminal of the fifth switch Q5 is electrically connected to the sources of the third switch Q3 and the fourth switch Q4.

The first terminal of the sixth switch Q6 is electrically connected to the third terminal of the fifth switch Q5 via the first resistor R1. The first terminal of the sixth switch Q6 is grounded via the second resistor R2. The second terminal of the sixth switch Q6 is grounded. The third terminal of the sixth switch Q6 receives a second DC voltage via the third resistor R3. The third terminal of the sixth switch Q6 outputs the detecting signals. In one embodiment, the third switch Q3, the fourth switch Q4, the fifth switch Q5, and the sixth switch Q6 are N channel MOSFETs. The first terminal, the second terminal, and the third terminal are always gate, source, and drain respectively. The second DC voltage is +5V.

In operation, when the gate of the first switch Q1 receives a low voltage level first control signal, then the gate of the third switch Q3 receives a high voltage level first control signal, and the gate of the fifth switch Q5 also receives a high voltage level second control signal, thus the first switch Q1, the third switch Q3, and the fifth switch Q5 turn on. The first motor M1 receives the +12V first DC voltage and rotates.

When the gate of the second switch Q2 receives the low voltage level first control signal, the gate of the third switch Q3 receives the high voltage level first control signal, and the gate of the fifth switch Q5 receives the high voltage level second control signal, and therefore the second switch Q2, the third switch Q3, and the fifth switch Q5 turn on. The second motor M2 receives the +12V first DC voltage and rotates.

When the gate of the first switch Q1 receives the low voltage level first control signal, the gate of the fourth switch Q4 receives the high voltage level first control signal, and the gate of the fifth switch Q5 receives the high voltage level second control signal, and thus the first switch Q1, the fourth switch Q4, and the fifth switch Q5 turn on. The third motor M3 receives the +12V first DC voltage and rotates.

When the gate of the second switch Q2 receives the low voltage level first control signal, the gate of the fourth switch Q4 receives the high voltage level first control signal, and the gate of the fifth switch Q5 receives the high voltage level second control signal, and thus the second switch Q2, the fourth switch Q4, and the fifth switch Q5 turn on. The fourth motor M4 receives the +12V first DC voltage and rotates.

In one embodiment, the first diode D1, the second diode D2, the third diode D3, and the fourth diode D4 are used to isolate the first motor M1, the second motor M2, the third motor M3, and the fourth motor M4 from the +12V first DC voltage to prevent unwanted rotation by a motor. When one of the four motors rotates, the first diode D1, the second diode D2, the third diode D3, and the fourth diode D4 prevent the +12V first DC voltage flowing to the other three motors.

When the system detects that the first motor M1 is connected to the system, the first control signals received by the gates of the first switch Q1 and the fourth switch Q4 and the second control signal received by the gate of the fifth switch Q5 are set as low voltage levels, and the first control signals received by the gates of the second switch Q2 and the third switch Q3 are set as high voltage levels. The first switch Q1 and the third switch Q3 turn on. The second switch Q2, the fourth switch Q4, and the fourth switch Q4 turn off. The gate of the sixth switch Q6 receives the +12V first DC voltage when the first motor M1 is connected to the system. The sixth switch Q6 turns on. The drain of the sixth switch Q6 outputs a low voltage level detecting signal to indicate that the first motor M1 is connected to the system. The gate of the sixth switch Q6 cannot receive the +12V first DC voltage when the first motor M1 is not connected to the system. The sixth switch Q6 turns off. The drain of the sixth switch Q6 outputs a high voltage level detecting signal to indicate that the first motor M1 is not connected to the system.

In a same manner as described above for indicating the connectedness or the non-connectedness of the first motor M1, the drain of the sixth switch Q6 outputs detecting signals of different voltage levels to indicate the second motor M2, the third motor M3, and the fourth motor M4 being connected to the system.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A motor driving system, comprising:
a first switch, a second switch, a third switch, a fourth switch, a first motor, a second motor, a third motor, and a fourth motor; each of the first, the second, the third, and the fourth switches comprises a first terminal, a second terminal, and a third terminal; each of the first, the second, the third, and the fourth motors comprises an anode and a cathode; the anode and the cathode of the first motor are electrically connected to the third terminals of the first and the third switches; the anode and the cathode of the second motor are electrically connected to the third terminals of the second and the third switches; the anode and the cathode of the third motor are electrically connected to the third terminals of the first and the fourth switches; the anode and the cathode of the fourth motor are electrically connected to the third terminals of the second and the fourth switches; the second terminals of the first and the second switches receive a first DC voltage; the second terminals of the third and the fourth switches are grounded;
wherein the first motor is adapted to rotate, according to each of the two first terminals of the first and the third switches receiving a first control signal to turn on the first and the third switches; the second motor is adapted to rotate, according to each of the two first terminals of the second and the third switches receiving the first control signal to turn on the second and the third switches; the third motor is adapted to rotate, according to each of the two first terminals of the first and the fourth switches receiving the first control signal to turn on the first and the fourth switches; and the fourth motor is adapted to rotate, according to each of the two first terminals of the second and the fourth switches receiving the first control signal to turn on the second and the fourth switches.

2. The motor driving system of claim 1, wherein the first and the second switches are P channel MOSFETs; and the third and the fourth switches are N channel MOSFETs.

3. The motor driving system of claim 1, further comprising a first diode, a second diode, a third diode, and a fourth diode; each of the first, the second, the third, and the fourth diodes comprises an anode and a cathode; the anodes of the first and the second diodes are electrically connected to the cathodes of the first and the second motors, respectively;
the cathodes of the first and the second diodes are electrically connected to the third terminal of the third switch; the anodes of the third and the fourth diodes are electrically connected to the cathodes of the third and the fourth motors, respectively; and the cathodes of the third and the fourth diodes are electrically connected to the third terminal of the fourth switch.

4. The motor driving system of claim 3, wherein the first, the second, the third, and the fourth diodes are Zener diodes.

5. The motor driving system of claim 1, further comprising a fifth switch, a sixth switch, a first resistor, a second resistor, and a third resistor; each of the fifth and the sixth switches comprises a first terminal, a second terminal, and a third terminal; the first terminal of the fifth switch receives a second control signal; the second terminal of the fifth switch is grounded; the third terminal of the fifth switch is electrically connected to the second terminals of the third and the fourth switches; the first terminal of the sixth switch is electrically connected to the third terminal of the fifth switch via the first resistor; the first terminal of the sixth switch is grounded via the second resistor; the second terminal of the sixth switch is grounded; the third terminal of the sixth switch receives a second DC voltage via the third resistor; and the third terminal of the sixth switch outputs detecting signals to indicate whether the motors are connected to the system.

6. The motor driving system of claim 5, wherein the first DC voltage is +12V; and the second DC voltage is +5V.

7. The motor driving system of claim 5, wherein the fifth and the sixth switches are N channel MOSFETs.

8. The motor driving system of claim 5, wherein the first, the second, and the third terminals are gate, source, and drain, respectively.

9. A motor driving system, comprising:
a first switch, a second switch, a third switch, a fourth switch, a first motor, a second motor, a third motor, and a fourth motor; the first motor is electrically connected to the first and the third switches; the second motor is electrically connected to the second and the third switches; the third motor is electrically connected to the first and the fourth switches; the fourth motor is electrically connected to the second and the fourth switches;
wherein the first motor is adapted to rotate, according to each of the first and the third switches receiving a first control signal to turn on the first and the third switches;
the second motor is adapted to rotate, according to each of the second and the third switches receiving the first control signal to turn on the second and the third switches; the third motor is adapted to rotate, according to each of the first and the fourth switches receiving the first control signal to turn on the first and the fourth switches; and the fourth motor is adapted to rotate, according to each of the second and the fourth switches receiving the first control signal to turn on the second and the fourth switches.

10. The motor driving system of claim 9, wherein each of the first, the second, the third, and the fourth switches comprises a first terminal, a second terminal, and a third terminal;
each of the first, the second, the third, and the fourth motors comprises an anode and a cathode; the anode and the cathode of the first motor are electrically connected to the third terminals of the first and the third switches, respectively; the anode and the cathode of the second motor are electrically connected to the third terminals of the second and the third switches, respectively; the anode and the cathode of the third motor are electrically connected to the third terminals of the first and the fourth switches, respectively; the anode and the cathode of the fourth motor are electrically connected to the third terminals of the second and the fourth switches, respectively; the second terminals of the first and the second switches receive a first DC voltage; and the second terminals of the third and the fourth switches are grounded.

11. The motor driving system of claim 10, wherein the first and the second switches are P channel MOSFETs; and the third and the fourth switches are N channel MOSFETs.

12. The motor driving system of claim 10, wherein each of the first terminals of the first, the second, the third, and the fourth switches receives the first control signal; and
the first, the second, the third, and the fourth switches control the first, the second, the third, and the fourth motors, respectively, to rotate according to the first control signal.

13. The motor driving system of claim 10, further comprising a first diode, a second diode, a third diode, and a fourth diode; each of the first, the second, the third, and the fourth diodes comprises an anode and a cathode; the anodes of the first and the second diodes are electrically connected to the cathodes of the first and the second motors, respectively; the cathodes of the first and the second diodes are electrically connected to the third terminal of the third switch; the anodes of the third and the fourth diodes are electrically connected to the cathodes of the third and the fourth motors, respectively; and
the cathodes of the third and the fourth diodes are electrically connected to the third terminal of the fourth switch.

14. The motor driving system of claim 13, wherein the first, the second, the third, and the fourth diodes are Zener diodes.

15. The motor driving system of claim 10, further comprising a fifth switch, a sixth switch, a first resistor, a second resistor, and a third resistor; each of the fifth and the sixth switches comprises a first terminal, a second terminal, and a third terminal; the first terminal of the fifth switch receives a second control signal; the second terminal of the fifth switch is grounded; the third terminal of the fifth switch is electrically connected to the second terminals of the third and the fourth switches; the first terminal of the sixth switch is electrically connected to the third terminal of the fifth switch via the first resistor; the first terminal of the sixth switch is grounded via the second resistor; the second terminal of the sixth switch is grounded; the third terminal of the sixth switch receives a second DC voltage via the third resistor; and the third terminal of the sixth switch outputs detecting signals to indicate whether the motors are connected to the system.

16. The motor driving system of claim 15, wherein the first DC voltage is +12V; and the second DC voltage is +5V.

17. The motor driving system of claim 15, wherein the fifth and the sixth switches are N channel MOSFETs.

18. The motor driving system of claim 15, wherein the first, the second, and the third terminals are gate, source, and drain, respectively.
